(19) United States
(12) Patent Application Publication
(10) Pub. No.: US 2007/0108920 A1
(43) Pub. Date: May 17, 2007

(54) Current-limit ballast for fluorescent lamp

(76) Inventor: Shien-Meng Lee, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/280,346

(22) Filed: Nov. 17, 2005

(51) Int. Cl. H05B 41/36

(52) U.S. Cl. 315/307

(57) ABSTRACT

A current-limit ballast for use in a fluorescent lamp is disclosed to include a bridge rectifier circuit, a filter circuit, a high-frequency pulse transformer, a choke, and a current-limit circuit electrically coupled to the filter circuit and the high-frequency pulse transformer and formed of a silicon controlled rectifier and a current-limit resistor to limit the range of the current to charge capacitors of the filter circuit for enabling the high-frequency pulse transformer to produce a high-frequency oscillation signal to trigger the silicon controlled rectifier.

### BACKGROUND OF THE INVENTION

1. Field of the Invention

The present invention relates to an electronic ballast for fluorescent lamp and more particularly to a current-limit ballast, which uses a current-limit circuit to limit the current that starts the fluorescent lamp, preventing damage to the fluorescent lamp.

2. Description of the Related Art

The electronic ballast of a regular fluorescent lamp is generally comprised of a rectifier circuit, a filter circuit, a pulse transformer, and a choke. The rectifier circuit rectifies AC into DC, which is then filtered by the filter circuit for enabling the pulse transformer to turn on the fluorescent lamp. This design of electronic ballast has numerous drawbacks as follows:
1. When started, electric current is rapidly charged to the capacitor of the filter circuit, and the charging current is excessively high.
2. When power resumes after a power failure, the starting current is high and may damage the capacity of the filter circuit.
3. When started to charge the capacitor of the filter circuit in a rush, the voltage and the starting current are high and may darken the ends of the fluorescent lamp, thereby shortening the service life of the fluorescent lamp.
4. The ballast provides no protection during output of power or a short-circuit, and an accident may occur easily.

### SUMMARY OF THE INVENTION

The present invention has been accomplished under the circumstances in provide current-limit ballast, which uses a current-limit circuit to limit the current that starts the fluorescent lamp, preventing damage to the fluorescent lamp. To achieve this and other objects of the present invention, the current-limit ballast comprises a bridge rectifier circuit, a filter circuit, a high-frequency pulse transformer, a choke, and a current-limit circuit electrically coupled to the filter circuit and the high-frequency pulse transformer and formed of a silicon controlled rectifier and a current-limit resistor to limit the range of the current to charge capacitors of the filter circuit for enabling the high-frequency pulse transformer to produce a high-frequency oscillation signal to trigger the silicon controlled rectifier. In an alternate form of the present invention, the current-limit circuit is formed of a TRIAC and a current-limit resistor.

### BRIEF DESCRIPTION OF THE DRAWINGS

FIG. 1 is a circuit diagram of a current-limit ballast according to a first embodiment of the present invention.

FIG. 2 is a circuit diagram of a current-limit ballast according to a second embodiment of the present invention.

### DETAILED DESCRIPTION. OF THE PREFERRED EMBODIMENT

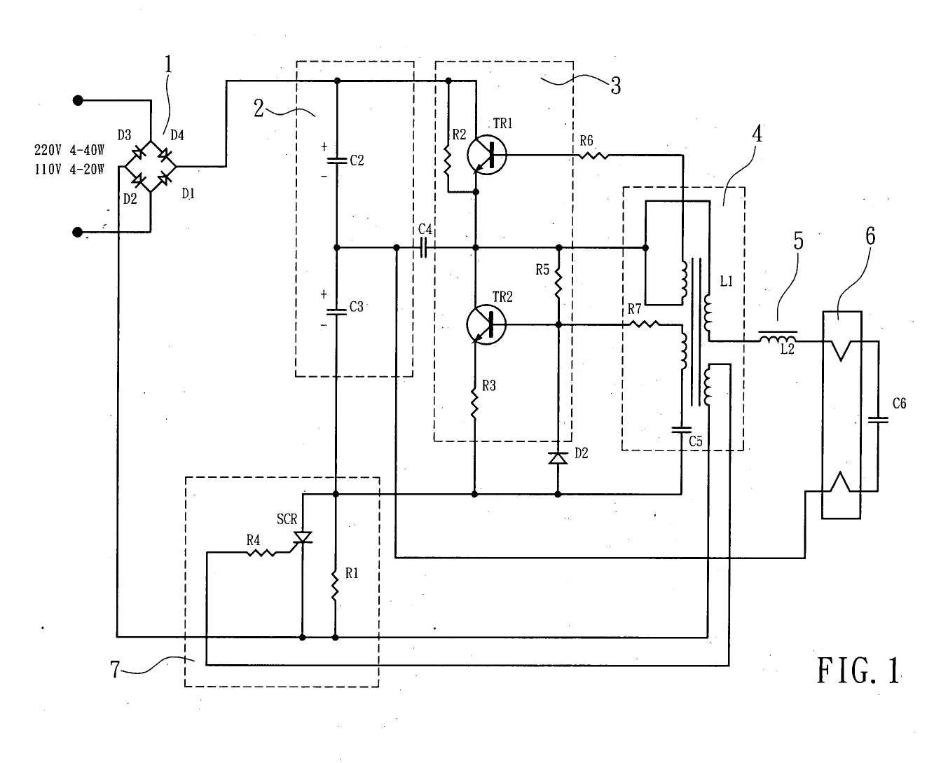

Referring to FIG. 1, a current-limit ballast for use in a fluorescent lamp 6 of 4 W˜40 W at AC220V (or of 4 W˜20 W at 110V) is shown comprising a bridge rectifier circuit 1 formed of four diodes D1˜D4 for full-wave rectification, a filter circuit 2 formed of capacitors C2 and C3, an oscillation circuit 3 formed of transistors TR1 and TR2 and biasing resistors R2 and R3, which transistors TR1 and TR2 being connected in parallel to the capacitors C2 and C3, a high-frequency pulse transformer 4, a choke 5, and a current-limit circuit 7 electrically coupled to the bridge rectifier circuit 1, the filter circuit 2 and the high-frequency pulse transformer 4, and formed of a silicon controlled rectifier SCR, a biasing resistor R4 and a current-limit resistor R1. The silicon controlled rectifier SCR is a triggering diode. The bridge rectifier circuit 1 rectifies AC into DC that passes through the current-limit circuit 7 to charge the capacitors C2 and C3 of the filter circuit 2 to the saturated status to further turn on the transistors TR1 and TR2 of the oscillation circuit 3, causing the oscillation circuit 3 to oscillate, and therefore a high frequency is produced and provided to the high-frequency pulse transformer 4. At this time, the high-frequency pulse transformer 4 is caused to produce a high-frequency pulse to turn on the silicon controlled rectifier SCR of the current-limit circuit 7, thereby starting the fluorescent lamp 6.

Because the current-limit circuit 7 is formed of a silicon controlled rectifier SCR and a current-limit resistor R1, only a limited current is allowed to pass and to further charge the capacitors C2 and C3 of the filter circuit 2. For example, when a 47KΩ 220V current-limit resistor R1 is used, the current value will be 220V÷47KΩ=0.005 A, therefore the maximum current allowed to pass to the fluorescent lamp 6 is 0.005 A.

This embodiment achieves the following advantages:
1. Easy to start: The current-limit starting action controls the current under a limited range for starting the fluorescent lamp easily.
2. Extend the life of the fluorescent lamp 6: The current-limit resistor R1 of the current-limit circuit 7 prevents transient high current that may damage the fluorescent lamp 6, and therefore the service life of the fluorescent lamp 6 is prolonged.
3. Prevent damage due to abnormal current: When a short circuit occurred or the fluorescent lamp 6 failed, the silicon controlled rectifier SCR is not oscillated, and the current is limited to a low range, preventing a damage.
4. No flashing: By means of the oscillation circuit 3 and the high-frequency pulse transformer 4, a high-frequency pulse is provided to drive the fluorescent lamp 6 to give off light without flashing.

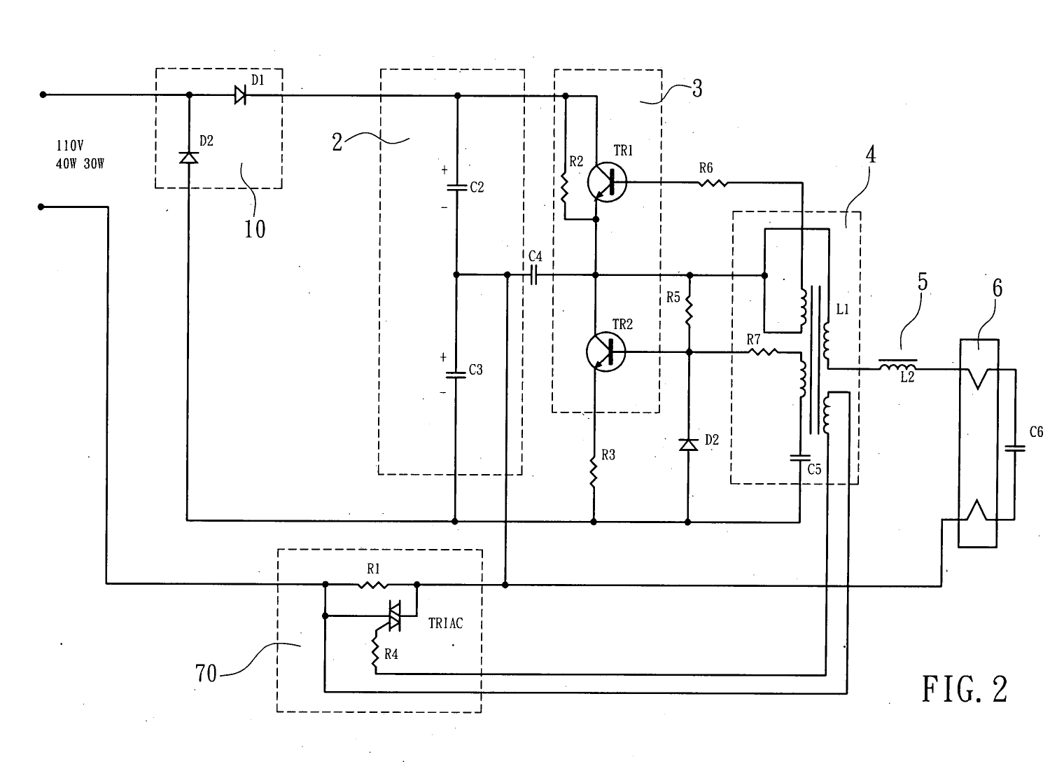

FIG. 2 shows the current-limit ballast for use in a fluorescent lamp 6 of 40 W (30 W) at AC110V. According to this embodiment, the rectifier circuit 10 is formed of two diodes D1 and D2; the current-limit circuit 70 is comprised of a TRIAC and a current-limit resistor R1. This embodiment achieves the same effect as the aforesaid first embodiment of the present invention.

Although particular embodiments of the invention have been described in detail for purposes of illustration, various modifications and enhancements may be made without departing from the spirit and scope of the invention.

What the invention claimed is:

1. A current-limit ballast for use in a fluorescent lamp, comprising a bridge rectifier circuit formed of four diodes for full-wave rectification, a filter circuit formed of two capacitors, an oscillation circuit formed of two transistors and a two biasing resistors, a high-frequency pulse transformer, a choke, said bridge rectifier circuit being adapted to rectify AC into DC for charging the capacitors of said filter circuit to the saturated status to further turn on the transistors of said oscillation circuit so as to cause said oscillation circuit to oscillate and to produce a high frequency for said high-frequency pulse transformer, said high-frequency pulse transformer being caused to produce a high-frequency pulse to start the fluorescent lamp when received the high frequency from said oscillator circuit, wherein a current-limit circuit is electrically coupled to said filter circuit and said high-frequency pulse transformer and formed of a silicon controlled rectifier and a current-limit resistor to limit the range of the current to charge the capacitors of said filter circuit for enabling said high-frequency pulse transformer to produce a high-frequency oscillation signal to trigger said silicon controlled rectifier.

2. A current-limit ballast for use in a fluorescent lamp, comprising a bridge rectifier circuit formed of four diodes for full-wave rectification, a filter circuit formed of two capacitors, an oscillation circuit formed of two transistors and a two biasing resistors, a high-frequency pulse transformer, a choke, said bridge rectifier circuit being adapted to rectify AC into DC for charging the capacitors of said filter circuit to the saturated status to further turn on the transistors of said oscillation circuit so as to cause said oscillation circuit to oscillate and to produce a high frequency for said high-frequency pulse transformer, said high-frequency pulse transformer being caused to produce a high-frequency pulse to start the fluorescent lamp when received the high frequency from said oscillator circuit, wherein a current-limit circuit is electrically coupled to said filter circuit and said high-frequency pulse transformer and formed of a TRIAC and a current-limit resistor to limit the range of the current to charge the capacitors of said filter circuit for enabling said high-frequency pulse transformer to produce a high-frequency oscillation signal to trigger said TRIAC.
